(19) United States
(12) Patent Application Publication
(10) Pub. No.: US 2003/0218714 A1
(43) Pub. Date: Nov. 27, 2003

(54) Liquid crystal display reducing color coordinate shift

(76) Inventors: Jang-Kun Song, Seoul (KR); Seung-Beom Park, Yongin-city (KR)

Correspondence Address: McGuireWoods LLP, 1750 Tysons Blvd, Suite 1800, McLean, VA, 22102, US

(21) Appl. No.: 09/940,606

(22) Filed: Aug. 29, 2001

(30) Foreign Application Priority Data
Aug. 29, 2000 (KR) 2000-50541

(51) Int. Cl. G06F 19/00

(52) U.S. Cl. 349/165

(57) ABSTRACT

An LCD having a liquid crystal layer with dye for compensating color shift is disclosed. The liquid crystal layer is disposed between a lower panel and an upper panel. The liquid crystal molecules are aligned vertical to the upper and lower panels, and the dye molecules have their major axes aligned parallel to the major axes of the liquid crystal molecules. In order to reduce of the transmittance, the dye may be such that light absorption curve of the dye coincides with light transmittance curve of a red color filter.

### BACKGROUND OF THE INVENTION

(a) Field of the Invention

The present invention relates to a liquid crystal display (referred to as an LCD hereinafter) and liquid crystal material used therefor, and more particularly, to an LCD of vertical alignment mode (referred to as VA mode hereinafter) for compensating color coordinate shift.

(b) Description of the Related Art

An LCD, in general, includes an upper panel having a common electrode and a plurality of color filters thereon, a lower panel having pluralities of thin film transistors (referred to as TFTs hereinafter) and pixel electrodes thereon, and a liquid crystal layer disposed between the upper and lower panels. Alignment of liquid crystal molecules in the liquid crystal layer is altered by the electric field generated by different voltages applied on the pixel electrodes and the common electrode, causing the change of the transmittance of light to display images.

VA mode LCDs are broadly used because of their high contrast ratio arid wide viewing angle.

However, color coordinate shift is one of principal problems related to VA mode LCDs. The color coordinate shift also acts as an obstacle to increase brightness. The color coordinate shift is such that the color of an LCD varies depending on the viewing direction and gray voltage, where colors usually get yellowish due to the color coordinate shift. That is, the color gets yellowish as it goes to the edge. A white color being sustained in a low gray becomes more yellowish as the gray gets higher.

### SUMMARY OF THE INVENTION

The present invention has been made in an effort to solve the above problem of a VA mode LCD and the object of the present invention is to provide an LCD reducing color coordinate shift.

To achieve the above object, this invention adds a dye such as a blue dye into liquid crystal layer.

More particularly, an LCD according to this invention includes a liquid crystal layer containing liquid crystal material and dye, the liquid crystal being disposed between first and second insulated substrates. The LCD also includes first and second electrodes to apply voltage to the liquid crystal layer.

Preferably, the dye is to transmit blue light only and liquid crystal molecules of the liquid crystal material are aligned vertical to the first and the second substrates. Furthermore, it is preferable that the molecules of the dye are aligned parallel to the liquid crystal molecules and that the content of dye in the liquid crystal layer is less then 2 w %. Preferably, the light absorption curve of the dye is such that the curve has a rise in the wavelength range between 550 nm and 570 nm and has maximum value in the wavelength range between 600 nm and 750 nm.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a cross-sectional view of a liquid crystal display according to a preferred embodiment of the present invention;

FIG. 2 is voltage-transmittance (referred to as VT hereinafter) curves of an LCD of vertical alignment mode for various wavelengths of light;

FIG. 3 is a graph showing the ratio of brightness of red light to the brightness of the blue light for various cell gaps;

FIG. 4 is a conceptual figure showing the principle of compensating color coordinate shift depending on the path of the light according to a preferred embodiment of the present invention;

FIG. 5 is a graph showing color coordinate shifts measured at the front of an LCD depending on the change of the applied voltage and on the change of the amounts of dye for various types of liquid crystal cells;

FIG. 6 is a graph showing the result of measurement of color coordinate shifts when 5.5V voltage is applied depending on the change of various amounts of dye for various types of liquid crystal cells;

FIG. 7 is a graph showing shift of x color coordinate depending on the voltage change and the viewing angle change for various types of cells;

FIG. 8 is VT curves of light for various types of cell;

FIG. 9 is a graph showing light transmittance curves of color filters and light absorption curve of a dye.

### DETAILED DESCRIPTION OF THE PREFERRED EMBODIMENTS

A preferred embodiment of the present invention will be hereinafter described with reference to the accompanying drawings.

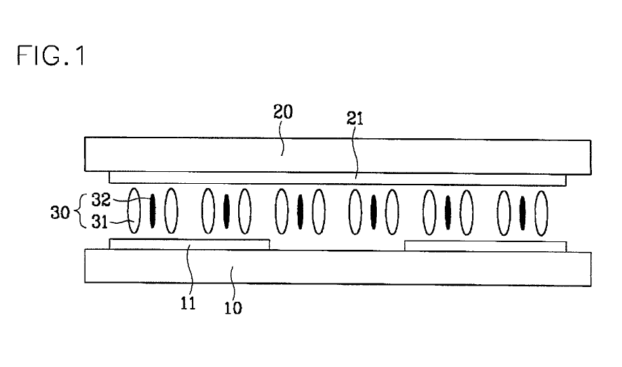

FIG. 1 is a cross-sectional view of a liquid crystal display according to a preferred embodiment of the present invention;

A liquid crystal layer 30 is disposed between a lower substrate 10 and an upper substrate 20. Pluralities of pixel electrodes 11, TFTs (not shown) as switching elements, gate lines (not shown), data lines (not shown) and so forth are formed on the lower substrate 10. A common electrode 21, a plurality of color filters (not shown), al black matrix (not shown) and so forth are formed on the upper substrate 20. The liquid crystal layer 30 contains pluralities of liquid crystal molecules 31 and blue dye molecules 32. The liquid crystal molecules 31 are vertically aligned with respect to the upper and lower substrates 10 and 20, and, similarly, the dye molecules 32 have their major axes aligned vertical to the substrates 10 and 20.

Addition of blue dye to the liquid crystal layer can reduce color coordinate shift.

The reason why the present invention can reduce color coordinate shift will be hereinafter described in detail.

The cause of color coordinate shift will be examined first.

Provided that effective retardation experienced by light_passing through a liquid crystal layer of electrically controlled birefringence mode where the molecules are not in a twisted state is (Δn)_{eff}·d where (Δn)_{eff} is an effective dielectric refractive indent of the liquid crystal layer and d is the thickness of the liquid crystal layer, the intensity I of the light out of the liquid crystal layer is given as the following equation 1.

I=A sin²{π(Δn)_{eff}·d/λ} (1)

where λ is the wavelength of the light. Increase of the voltage applied to the liquid crystal layer increases the change of the alignment of the liquid crystal molecules from the initial state, and accordingly the value of (Δn)_{eff}·d also increases so that the transmittance of light increases. Since the equation 1 contains wavelength λ as a factor to define the intensity of light, the VT curve varies depending on the wavelength λ.

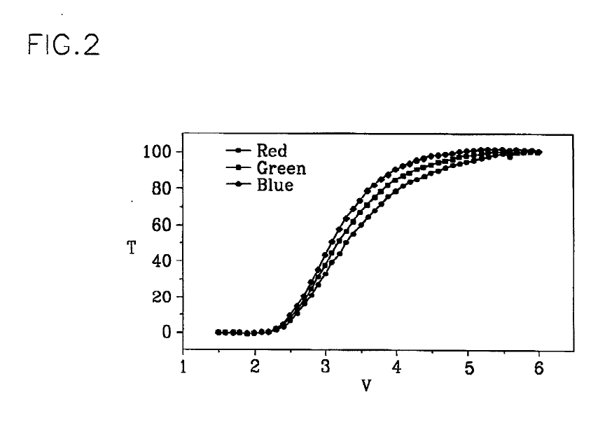

FIG. 2 is VT curves of an LCD of vertical alignment mode for various wavelengths of incident light;

FIG. 2 is a normalized graph of VT curves for various wavelengths of light. As shown in FIG. 2, a VT curve varies slightly depending on the wavelength so that the color coordinate shifts depending on the gray level. That is, as the applied voltage increases, the transmittance of red light increases steeper than that of blue light, so that a yellowish phenomenon is resulted.

The same phenomenon is observed when the viewing direction moves from the center of the display to the right or left sides. This is because, as seen in equation 1, the amount of color coordinate shift becomes greater as (Δn)_{eff}·d increases. The factor (Δn)_{eff}·d of the light when viewed from the edge is greater than when viewed at front because the light viewed from the edge has more length of path than the light viewed at front.

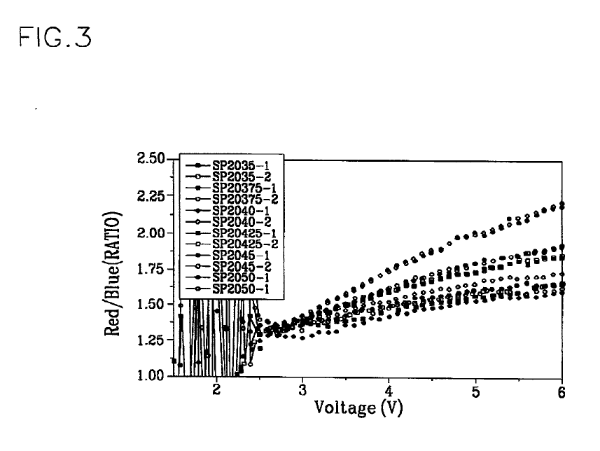

FIG. 3 is a graph showing the ratio of brightness of red light to the brightness of the blue light as a function of applied voltage for various cell-gaps.

As shown in FIG. 3, the ratio of brightness of red light to the brightness of the blue light increases as the applied voltage increases. In other words, the color coordinate shifts to red as the voltage increases. Also, as the cell gap increases, the ratio increases so that the color coordinate shifts to red.

To solve the above problem of color coordinate shift, color coordinate shift has to be compensated in proportion to the factor (Δn)_{eff}·d. This invention adds blue dye to the liquid crystal layer to solve the above problem.

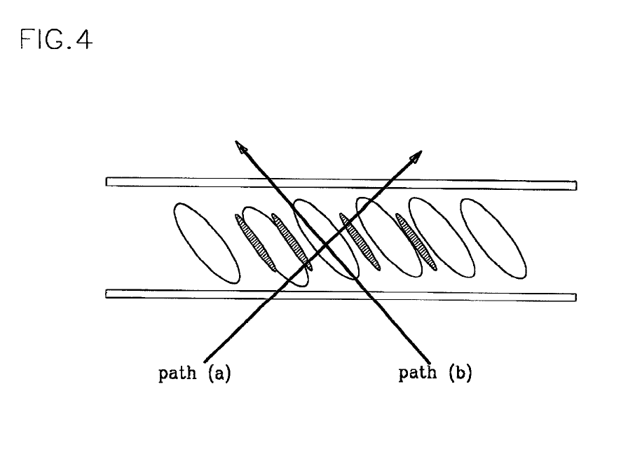

FIG. 4 is a conceptual figure showing the principle of compensating color coordinate shift depending the path of the light according to a preferred embodiment of the present invention;

The path (a) is a path of light that goes nearly perpendicular to the major axis of the liquid crystal molecules, and the path (b) is a path of light that goes parallel to the major axis of a liquid crystal molecule.

Due to the birefringence of liquid crystal material, the factor (Δn)_{eff}·d for the path (a) is greater than that for the path (b).

Light absorption characteristic of blue dye molecules is also dependent on the path along which the light passes.

When the light passes along the path (a) perpendicular to the major axes of the dye molecules, quite amount of red component is absorbed so that the light has a strong tendency to be blue. On the contrary, when the light passes along the path (b) parallel to it's the major axes, the absorption of red component is small so that the tendency to be blue is weakened.

Accordingly, the light passing through the path (a) has large color coordinate shift to red but the shift is so much compensated by the dye molecules. Similarly, the light passing through the path (b) has small color coordinate shift to red but the shift is so much compensated by dye molecules. As a result, the color coordinate of light becomes to depend not so much on the path.

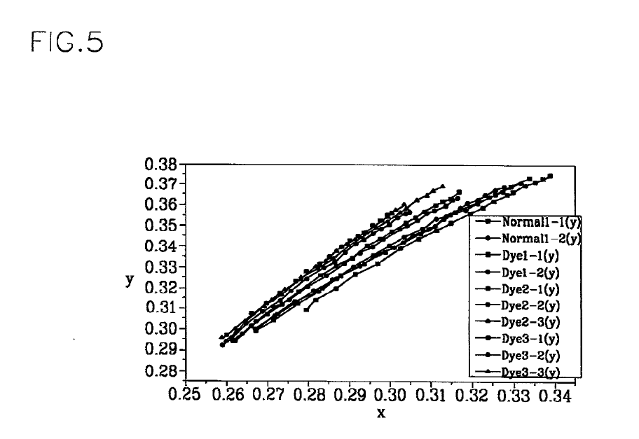

FIG. 5 is a graph showing color coordinate shift measured at front of an LCD for various applied voltages and various densities of dye.

The applied voltage is varied from 2.6V up to 6V by 0.2V. The results when the applied voltage is smaller than 2.6 V are not included since the deviation is too large. As shown in FIG. 5, absolute value and amount of color coordinate shift are reduced as the density of dye increases.

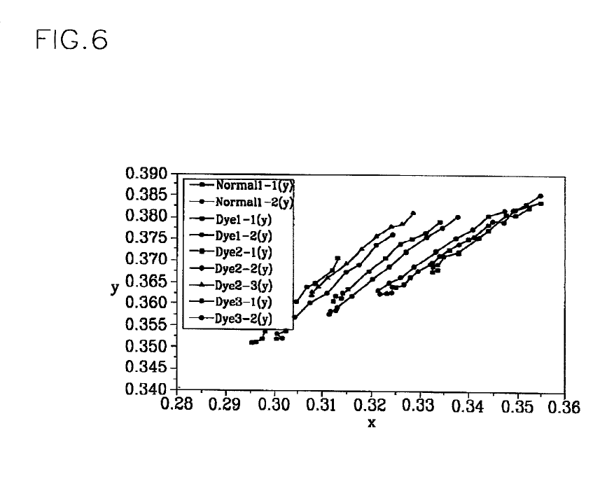

FIG. 6 is a graph showing the result of measurement of color coordinate shift for various viewing directions and various amounts of dye when 5.5V voltage is applied.

The color coordinates are measured for the viewing angle from 0 degree to 50 degrees. The graph shows that the color coordinate shifts toward yellow when the viewing angle moves from the front to the edge. The amounts of color coordinate shift are almost the same level but the absolute value of color coordinate shows dependency on the amount of dye.

Table 1 shows amount of x-coordinate shift, which affect much on visibility, in relation to voltage and viewing angle.

TABLE 1

| | x-coordinate in relation to | | | x-coordinate in relation to | | | | |
|---|---|---|---|---|---|---|---|---|
| | voltage | | | viewing angle | | | SUM | |
| | | | | | | | | Relative |
| | 2.6 V | 6 V | Δ₁ | front | edge | Δ₂ | Δ₁ + Δ₂ | value |
| Normal 1 | 0.2775 | 0.3342 | 0.0567 | 0.3282 | 0.3549 | 0.0267 | 0.0834 | 100.9 |
| Normal 2 | 0.277 | 0.3295 | 0.0525 | 0.3251 | 0.3545 | 0.0294 | 0.0819 | 99.1 |
| Dye 1-1 | 0.2868 | 0.3393 | 0.0525 | 0.3336 | 0.3523 | 0.0187 | 0.0712 | 86.1 |
| Dye 1-2 | 0.3197 | 0.3737 | 0.054 | 0.3232 | 0.3471 | 0.0239 | 0.0779 | 94.3 |
| Dye 2-1 | 0.2701 | 0.317 | 0.0469 | 0.3137 | 0.334 | 0.0203 | 0.0672 | 81.3 |
| Dye 2-2 | 0.272 | 0.3169 | 0.0449 | 0.3127 | 0.3376 | 0.0249 | 0.0698 | 84.5 |
| Dye 2-3 | 0.2648 | 0.3131 | 0.0483 | 0.3076 | 0.3287 | 0.0211 | 0.0694 | 84.0 |
| Dye 3-1 | 0.2623 | 0.3007 | 0.0384 | 0.2975 | 0.3131 | 0.0156 | 0.054 | 65.3 |
| Dye 3-2 | 0.2731 | 0.305 | 0.0319 | 0.3016 | 0.3243 | 0.227 | 0.0546 | 66.1 |

The symbol Δ₁ denotes the difference of x color coordinate between the applied voltages of 6V and 2.6V, and the symbol Δ₂ denotes a difference of x color coordinate between values taken from the front and the edge.

It is understood from the table 1 that the amount of color coordinate shift decreases as the density of dye increases.

The total amount of color coordinate shift can be calculated as a sum of amounts of shift in relation to the voltage and the viewing angle.

As shown in table 1, the total amount of shift of color coordinates for dye 1 is reduced by approximately 10% in comparison with the case of normal cell, by approximately 17% for dye 2, and by approximately 35% for dye 3.

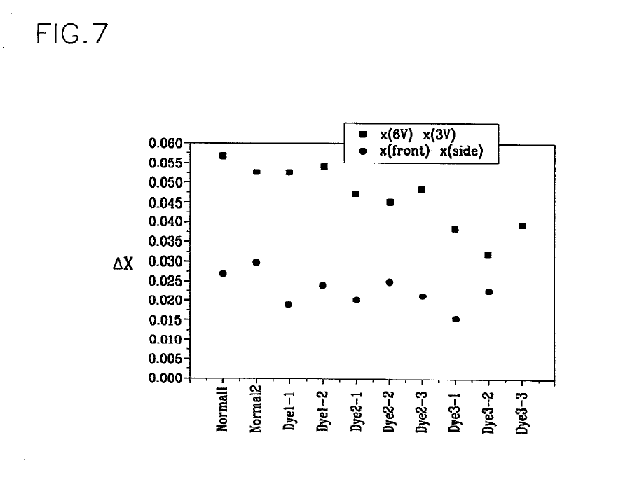

FIG. 7 is a graph showing shift of x color coordinate of various types of cell due to the change of the applied voltage and due to change of the viewing direction.

As shown in FIG. 7, the amount of color coordinate shift for the gray level change (or voltage change), i.e., when the voltages are 3V and 6V at the front is approximately twice of that for the viewing angle change, i.e., when the viewing angles are 0 degree and 50 degrees.

While the amount of color coordinate shift due to the gray level change varies a lot depending on the density of dye, the amount of color coordinate shift due to the viewing angle change depends not so much on the density of the dye.

As shown above, the color coordinate shift can be compensated by adding dye to the liquid crystal layer. However, it is expected that that brightness be reduced by the addition of the dye, which is examined hereinafter in detail.

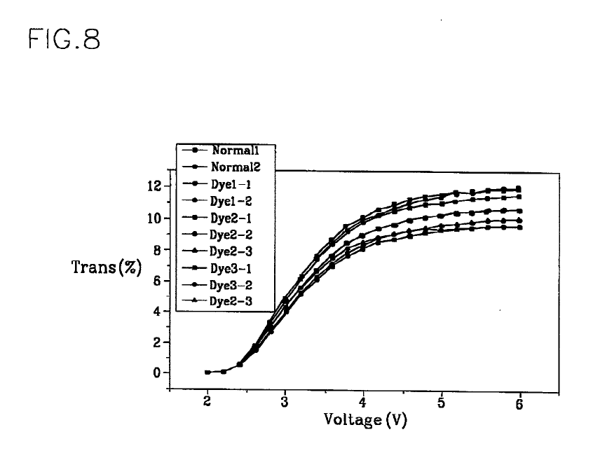

FIG. 8 is VT curves for various types of cells, and table 2 shown below is to compare transmittance of different types of cells.

TABLE 2

| | Transmittance | Relative value |
|---|---|---|
| Type of cell | (%) | (%) |
| Normal | 11.66 | 100 |
| Dye 1 | 11.38 | 97.6 |
| Dye 2 | 10.3 | 88.3 |
| Dye 3 | 9.44 | 81.0 |

As shown in FIG. 8, the transmittance is reduced as the density of dye increases. The table 2 shows that the type of dye also can affect the transmittance. Being normalized with respect to a normal cell, which is set to be 100%, the transmittance of a cell with dye 3 is found to be 81%, which is approximately 19% lower than that of a normal cell.

The reason why the transmittance is reduced so much can be understood by comparing absorption curve of a dye and transmittance curve of a color filter.

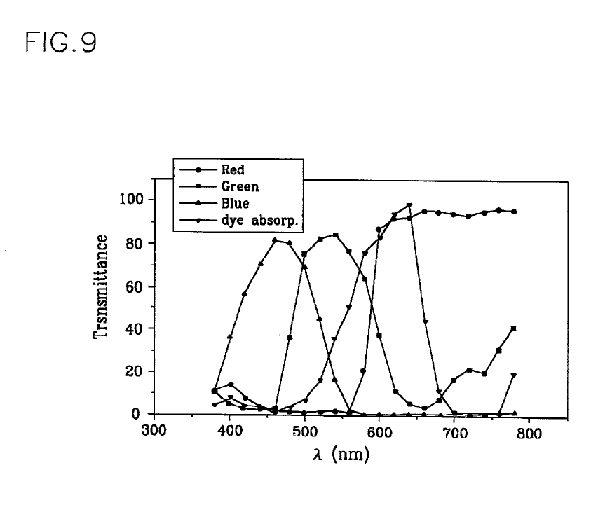

FIG. 9 is a graph showing light transmittance curve of a color filter and light absorption curve of a dye as a function of wavelength of the light.

As shown in FIG. 9, the dye absorbs substantial amount of the green light in the almost half of the full wavelength range. Consequently, the reduction of the transmittance is inevitable. The absorption curve shows that the light of long wavelength such as more than 660 nm is hardly absorbed. This unabsorbed light of long wavelength plays a part in reducing efficiency of compensating color coordinate shift.

To efficiently compensate color coordinate shift without decrease of brightness, a dye preferably absorb red light only.

Accordingly, a dye is preferably chosen, of which absorption curve coincides with the transmittance curve of a red color filter, which has a rise from the value near or larger than 550 nm.

According to the present invention as described above, color coordinate shift toward yellow can be compensated. Although the transmittance may be reduced by the addition of the dye, a dye having a light absorption curve coinciding the light transmittance curve of a red color filter may be chosen to improve transmittance. In addition, it is understood that the advantage of the enhancement of transmittance achieved by compensating color coordinates may overcome the disadvantage of the decrease of the transmittance.

What is claimed is:

1. A liquid crystal display comprising:
a first insulating substrate;
a second insulating substrate disposed opposite to the first substrate;
a liquid crystal layer containing liquid crystal material and dye, the liquid crystal being disposed between the first and the second substrates; and
first and second electrodes cooperating to apply electric field to the liquid crystal layer.

2. A liquid crystal display of claim 1, wherein the dye transmits blue light only.

3. A liquid crystal display of claim 2, wherein liquid crystal molecules of the liquid crystal material are aligned vertical to the first and the second substrates.

4. A liquid crystal display of claim 3, wherein molecules of the dye are aligned parallel to the liquid crystal molecules.

5. A liquid crystal display of claim 3, wherein content of the dye in the liquid crystal layer is equal to or less than 2 w %.

6. A liquid crystal display of claim 1, wherein the light absorption curve of the dye is such that the curve has a rise in the range between 550 nm and 570 nm of the wavelength of the light and has a maximum value in the range between 600 nm and 750 nm.
